(19) United States
(12) Patent Application Publication
(10) Pub. No.: US 2024/0238985 A1
(43) Pub. Date: Jul. 18, 2024

(54) FORCE SENSOR ASSEMBLY FOR ARTICULATED MECHANISM

(71) Applicant: KINOVA INC., Boisbriand (CA)

(72) Inventors: Louis-Pierre FORTIN, Montreal (CA); André CLAVEAU, Prévost (CA); Mathiew MOINEAU-DIONNE, Mirabel (CA); Benoit GILBERT, Lac-Beauport (CA)

(21) Appl. No.: 18/563,907

(22) PCT Filed: May 25, 2022
(86) PCT No.: PCT/CA2022/050826

§ 371 Date: Nov. 23, 2023

Related U.S. Application Data
(60) Provisional application No. 63/192,754, filed on May 25, 2021.

(51) Int. Cl. B25J 13/08

(52) U.S. Cl. CPC B25J 13/085

(57) ABSTRACT

A force sensor assembly for a mechanism may have an annular structure configured for securing the force sensor assembly to a link of a mechanism. A hub is configured to be connected to a support a tool. Branches extending from the hub to the annular structure, the branches defining sensor receiving surfaces. Sensors on the sensor receiving surfaces. A robot arm including the force sensor assembly is described.

### CROSS-REFERENCE TO RELATED APPLICATION

The present application claims the priority of U.S. Patent Application No. 63/192,754, filed on May 25, 2021 and incorporated herein by reference.

### TECHNICAL FIELD

The present application relates to robot arms or like articulated mechanisms and to force and torque sensors therefor.

### BACKGROUND OF THE ART

Robotic arms are increasingly used in a number of different applications, from manufacturing, to servicing, and assistive robotics, among numerous possibilities. Serial robot arms are convenient in that they cover wide working volumes. To ensure their precise control, serial robot arms are provided with force sensors, including with torque sensing capability, to monitor effectively actions being performed by the end effectors of robotic arms. Due to the limited space within robot arms, it remains a design challenge to devise sensor assemblies that may measure precisely forces/torque at the end effector, while optimizing their use of available space. As they are usually separate from the robot, force sensors may be susceptible to integration issues—temperature variations, varied strain in materials from the attachment method, etc. In addition, when force sensors are placed between the last joint and end effector interface, force sensors may not provide suitable readings pertaining to hand guiding in a collaborative mode when manipulated by a user, or when collisions occur. Lastly, when they are independent from the robot arm, the force sensors cannot self-validate or use sensor fusion (for example using joint torque measures or estimations) to enhance the accuracy of the sensor values.

### SUMMARY

It is an aim of the present disclosure to provide a robot arm that addresses issues related to the prior art.

Therefore, in accordance with a first aspect of the present disclosure, there is provided a force sensor assembly for a mechanism, comprising: an annular structure configured for securing the force sensor assembly to a link of a mechanism; a hub configured to be connected to a support a tool; branches extending from the hub to the annular structure, the branches defining sensor receiving surfaces; and sensors on the sensor receiving surfaces.

Further in accordance with the first aspect, for example, three of the branches are provided.

Still further in accordance with the first aspect, for example, the three branches are spaced by 120 degrees.

Still further in accordance with the first aspect, for example, the branches and the hub are generally axisymmetric.

Still further in accordance with the first aspect, for example, the branches, the hub, and the annular structure are generally axisymmetric.

Still further in accordance with the first aspect, for example, the branches are perpendicular to respective surfaces of the hub to which the branches connect.

Still further in accordance with the first aspect, for example, the branches are perpendicular to respective surfaces of the annular structure to which the branches connect.

Still further in accordance with the first aspect, for example, fillets may be at junctions between the branches and the hub.

Still further in accordance with the first aspect, for example, fillets may be at junctions between the branches and the annular structure.

Still further in accordance with the first aspect, for example, the sensor receiving surfaces are flat.

Still further in accordance with the first aspect, for example, planes of the sensor receiving surfaces are perpendicular to planes of respective surfaces of the hub to which the branches connect.

Still further in accordance with the first aspect, for example, planes of the sensor receiving surfaces are perpendicular to planes of respective surfaces of the annular structure to which the branches connect.

Still further in accordance with the first aspect, for example, the branches have a portion with a rectangular cross-section.

Still further in accordance with the first aspect, for example, the annular structure is polygonal.

Still further in accordance with the first aspect, for example, the annular structure is hexagonal.

Still further in accordance with the first aspect, for example, the hub defines a central opening.

Still further in accordance with the first aspect, for example, connection bores are defined in the hub.

Still further in accordance with the first aspect, for example, the connection bores are circumferential offset from the branches.

Still further in accordance with the first aspect, for example, a printed circuit board may be connected to the sensors.

Still further in accordance with the first aspect, for example, at least one post projects from the hub, the printed circuit board connected to the at least one post.

Still further in accordance with the first aspect, for example, a plane of the printed circuit board is parallel to a plane of the hub.

Still further in accordance with the first aspect, for example, flexible circuits may extend from the sensors to the printed circuit board.

Still further in accordance with the first aspect, for example, a tool support member may be connected to the hub and configured to interface a tool to the hub.

Still further in accordance with the first aspect, for example, the tool support member has a plate body with an elongated shape, the plate body in planar engagement with a surface of the hub.

Still further in accordance with the first aspect, for example, hub connection holes in the tool support member for connection with the hub are inward of tool connection holes in the tool support member for connection with the tool.

Still further in accordance with the first aspect, for example, clocking features are present between the tool support member and the hub for providing a unique orientation engagement therebetween.

Still further in accordance with the first aspect, for example, the tool support member has a central opening in register with a central opening in the hub.

In accordance with a second aspect of the present disclosure, there is provided a robot arm comprising: at least one link having a motorized joint unit; a wrist device; and the force sensor assembly as describe above between the motorized joint unit and the wrist device, the wrist device being to the tool and the at least one link being the mechanism.

Further in accordance with the second aspect, for example, the wrist device has a tubular shell and an end face, the tubular shell surrounding the annular structure of the force sensor assembly, and the end face secured to the force sensor assembly.

Still further in accordance with the second aspect, for example, the tubular shell used for manipulation is cantilevered to the force sensor assembly by the end face.

Still further in accordance with the second aspect, for example, the annular structure is connected to a shell of the motorized joint unit.

### DESCRIPTION OF THE DRAWINGS

FIG. 1 is a perspective view of an articulated robot arm with a force sensor assembly in accordance with an embodiment of the present disclosure;

FIG. 2 is an enlarged view of a wrist device of the articulated robot arm of FIG. 1, incorporating the force sensor assembly of the present disclosure;

FIG. 3 is a longitudinal section view of the wrist device of FIG. 2;

FIG. 4 is a distal perspective of a structure of the force sensor assembly of the present disclosure;

FIG. 5 is a proximal perspective of the structure of FIG. 4;

FIG. 6 is an enlarged view showing a collaboration between the structure of FIG. 4 and a sensor assembly; and

FIG. 7 is a distal perspective of the structure of FIG. 4 with a tool support member.

### DETAILED DESCRIPTION

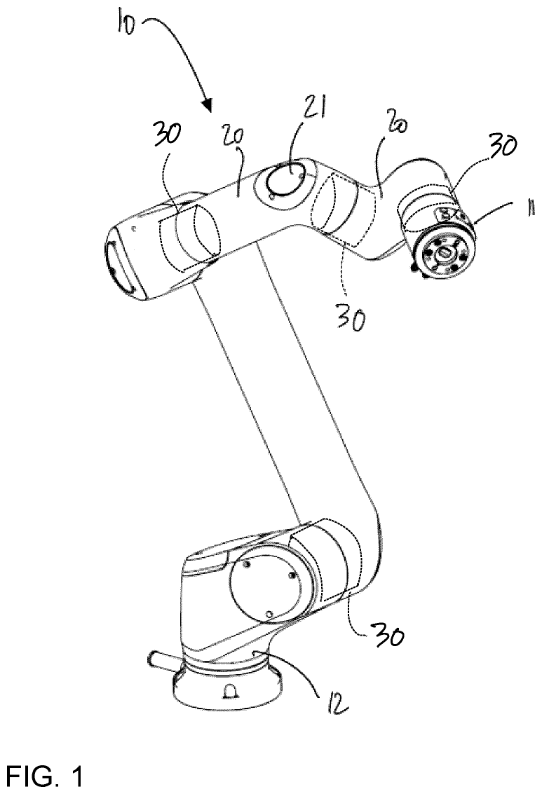

Referring to the drawings and more particularly to FIG. 1, a mechanism such as a robot arm in accordance with the present disclosure is generally shown at 10. Although the force sensor assembly described herein is shown on the robot arm 10, it may be used with other mechanisms, such as articulated mechanisms, or like mechanisms. However, for simplicity, the expression “robot arm” is used throughout, but in a non-limiting manner.

The robot arm 10 is a serial articulated robot arm, having a working end 11 and a base end 12. The working end 11 is configured to receive an end effector that may be any appropriate tool, such as gripping mechanism or gripper, anamorphic hand, and tooling heads such as drills, saws, etc. The end effector secured to the working end 11 is as a function of the contemplated use. However, the robot arm 10 is shown without any such tool in FIG. 1. The base end 12 is configured to be connected to any appropriate structure or mechanism. The base end 12 may be rotatably mounted or not to the structure or mechanism. By way of non-exhaustive example, the base end 12 may be mounted to a wheelchair, to a vehicle, to a frame, to a cart, to a robot docking station. Although a serial robot arm is shown the joint arrangement of the robot arm 10 may be found in other types of robots, included parallel manipulators.

The robot arm 10 has a series of links 20 (also known as shells), interconnected by motorized joint units 30 (schematically shown in FIG. 1). The links 20 define the majority of the outer surface of the robot arm 10, but could be concealed under non-structural skins. The links 20 also have a structural function in that they form the skeleton of the robot arm 10 (i.e., an outer shell skeleton), by supporting the motorized joint units 30 and tools at the working end 11, with loads supported by the tools, in addition to supporting the weight of the robot arm 10 itself. Wires and electronic components may be concealed into the links 20, by internal routing, although this is optional. Caps 21 may be provided in the links 20 to provide an access to the motorized joint units 30, for assembling and disassembling the robot arm 10, etc.

The links 20 may be defined by a tubular body. An outer peripheral surface of the tubular bodies forms the majority of the exposed surface of the robot arm 10 but the tubular bodies could be concealed under non-structural skins, and/or the links 20 could have other configurations than a tubular body as a possibility. The tubular bodies may differ in length, in diametrical dimension, and in shape. For example, as shown in FIG. 1, some of the links 20 may be generally straight or angled, i.e., arranged such that the rotation angles of the motorized joint units 30 at their opposed ends are parallel, perpendicular, or at any other angle. Some links 20 may be longer, etc. Also, although the open ends of the tubular bodies of the links 20 may have the same diameter for all motorized joint units 30 to be the same size, it is contemplated to scale down the motorized joint units 30 from the proximal base end 12 to the distal working end 11 to reduce the overall weight of the robot arm 10. In such a case, the diameter of the open ends of the links 20 may incrementally reduce toward the distal end. The tubular bodies of the links 20 may consist of any appropriate material, including composites, plastics, metals, or any combination thereof. The tubular bodies may be monolithic pieces, or an assembly of components, and may be molded, extruded, machined, etc.

The motorized joint units 30 interconnect adjacent links 20, in such a way that a rotational degree of actuation is provided between adjacent links 20. According to an embodiment, the motorized joint units 30 may also connect a link 20 to a tool at the working end 11 (e.g., via wrist device 40), or to a base at the base end 12, although other mechanisms may be used at the working end 11 and at the base end 12. The motorized joint units 30 may also form part of structure of the robot arm 10, as they interconnect adjacent links 20.

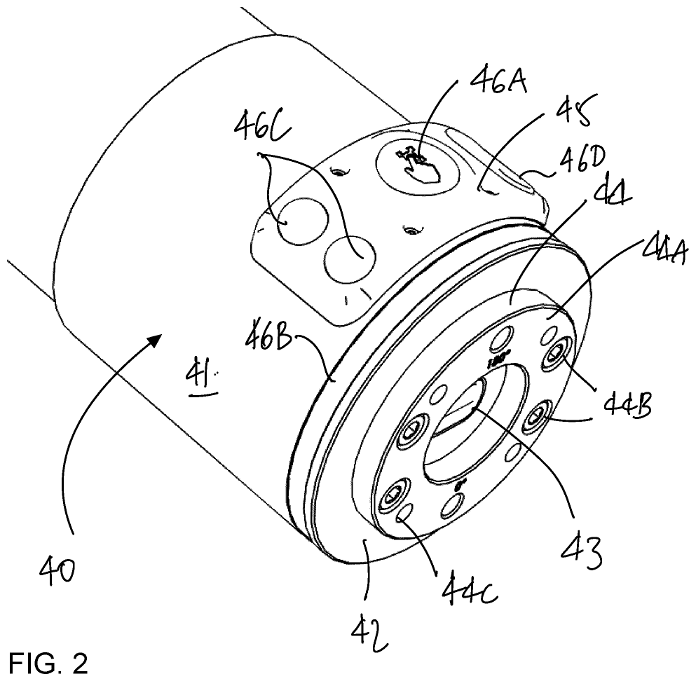

The working end 11 features a wrist device 40 (FIG. 2) connected to the adjacent link 20 by one of the motorized joint units 30. The wrist device 40 is also a link, but is referred to as a wrist device 40 as it interfaces the robot arm 10 to an end effector (not shown), and provides at least one rotation degree of freedom (DOF) to the end effector, relative to the adjacent link 20. Other expressions may be used to describe the wrist device 40, such as wrist, wrist unit, interconnect, link, link assembly, etc. In an embodiment, the force sensor assembly of the present disclosure is integrated into the wrist device 40. However, the force sensor assembly may be in other ones of the links 20 of the robot arm 10. The robot arm 10 may also have more than one of the force sensor assembly, for example at the base of the robot arm 10.

Referring to FIGS. 1-3, the wrist device 40 is shown having a shell 41 that may be tubular so as to accommodate hardware of the robot arm 10, including a motorized joint unit 30 or part of it, as described below. The shell 41 is a structural component of the wrist device 40, as it must support an end effector. The shell 41 may be made of a metal, an alloy, or a high-density plastic, as examples among others. The shell 41 may be mounted over a motorized joint unit 30, and coupled to it by the force sensor assembly 100, as detailed below. The shell 41 may be slid over the motorized joint unit 30 and/or tubular body of a link 20, with a seal(s) 41A optionally being present to close a gap therebetween, and to contribute to a cantilevered condition of the wrist device 40 as described below. The cantilevering of the wrist device 40 may contribute to the sensitivity of the force-torque sensor described herein. The reverse arrangement is also contemplated, or an end to end assembly is yet another alternative. In an embodiment, the arrangement with the seal(s) 41A contributes to reducing heat conduction, as the shell 41 is in a floating condition relative to the structure it surrounds. The seal(s) 41A is made of an elastomer in a variant.

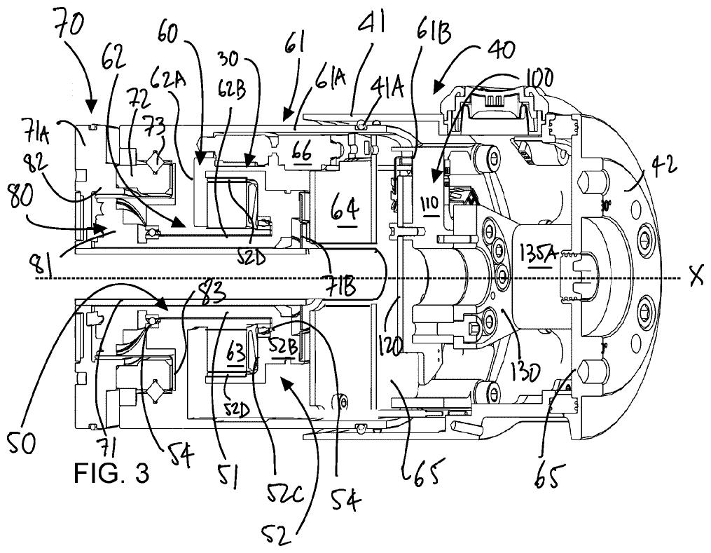

An end face 42 is at a distal end of the shell 41. In a variant, the end face 42 may be a plate, and may or may not be an integral part of the shell 41, though shown as being a separate component in FIG. 3. The end face 42 may be the portion of the wrist device 40 that connects to an end effector. Therefore, the end face 42 may have various coupling hardware components, such as a socket(s) 43, and a connection ring 44 that may define a shoulder 44A. Other components may include plugs, fasteners 44B, other sockets, connection holes 44C (e.g., threaded). The connection holes 44C may be used to fix an end effector (i.e., any appropriate tool) to the wrist device 40, as a possibility. The various components on the surface of the end face 42 may be appropriately wired internally for the components to provide powering and/or signalling to the end effector. The shell 41 and end face 42 may from an integral component, structurally connected to the robot arm 10 via the force sensor assembly 100 described below. Accordingly, the proximal end of the shell 41 may be cantilevered, and this may increase the sensitivity of the force sensor assembly 100 for side impacts on the wrist device 40, including for collisions and contacts. Manipulations of the robot arm 10 via the wrist device 40 may result in enhanced moment forces because of the cantilevered configuration.

An integrated interface 45 may also be provided. The integrated interface 45 may have a button 46A, LED display 46B (e.g., ring of light), other buttons 46C and level button 46D (e.g., +/−) as examples of interfaces that may also include a screen, a touchscreen, dials, knobs, switches, sensors, etc. The button 46A may for example be an admittance control button. The integrated interface 45 may also be appropriately wired internally for the components to provide powering and signalling to the end effector, and/or for the user to enter commands in the robot arm 10. The integrated interface 45 is one possible way to communicate with the controller of the robot arm 10. Other interfaces may be at the base end 12, as a self-enclosed separate device, or as a wireless device (e.g., tablet, smart phone).

Referring to FIG. 3, one of the motorized joint units 30 is illustrated, in relation to the wrist device 40. While some of the components may be described as being part of the motorized joint unit 30, it may alternatively be part of the wrist device 40. Moreover, the wrist device 40 may be said to integrated the motorized joint unit 30. The motorized joint unit 30 is shown in a simplified format, as the present disclosure focuses on the force sensor assembly associated with the motorized joint unit 30 and/or wrist device 40. The motorized joint unit 30 is of the type having a rotor assembly 50, a stator assembly 60 rotatable relative to the rotor assembly 50 along rotational axis X, as a response to actuation from the motorization components inside the motorized joint unit 30. In the illustrated variant, the stator assembly 60 is coupled to the wrist device 40 for concurrent rotation, i.e., the stator assembly 60 constitutes the output of the motorized joint unit 30. The rotor assembly 50 and the stator assembly 60 may be supported by a base 70, the base 70 being connected to a distal link 20 (e.g., to a motorized joint unit 30 thereof). The base 70 may serve as a structure or skeleton for the rotor assembly 50 and the stator assembly 60. Moreover, a reduction mechanism 80 may be present, to reduce the speed from the rotor assembly 50 to the stator assembly 60, and increase torque output.

Referring to FIG. 3, the rotor assembly 50 has a shaft 51. The shaft 51 may be hollow, for wires to extend from a downstream link 20 to the wrist device 40, for instance via part of the base 70 as described below.

A support 52 may be mounted onto the shaft 51, and may be fixed to the shaft 51. The support 52 may also form part of the structure of the rotor assembly 50, as the support 52 forms part of the skeleton supporting the weight of some of the components of the wrist device 40. The support 52 may have a drum-like feature 52C, that may be supported by a radial portion 52B projecting from the shaft 51. The radial portion 52B may be substantially radial, i.e., axis X may be normal to its plane, but other arrangements are possible as well. The drum 52C may be connected to an outer end of the radial portion 52B. The drum 52C may be cylindrical, frusto-conical, etc. In an embodiment, the shaft 51 is concentric with the drum 52C, relative to axis X.

An annular receptacle may consequently be defined by an outer surface of the shaft 51, the radial portion 52B, and the drum 52C. Magnets 52D may be present, as an option, in the annular receptacle, and may be located an inner annular surface of the drum 52C. The annular receptacle receives therein parts of the motor that imparts a rotation to the rotor assembly 60, forming the motor with the magnets 52D. The motor is schematically shown, as it may be any appropriate type of actuator, including an electric motor, a pneumatic or hydraulic actuator, etc. The motor may for example include a stator core with windings thereon, according to an embodiment. However, for simplicity, the windings and stator core are not shown in the figures. The electric motor, or like actuator, is operated to provide the desired rotation between adjacent links 20, for example in terms of speed and torque, relative to axis X. The motor or like actuator is configured for reciprocating movement (i.e., clockwise and counterclockwise), and low frequency movements, for some implementations of the robot arm 10. Non exhaustive or limitative rotor/stator kits that may be used include an external rotor motor (e.g., brushless), axial flux or pancake-type motor (brushed, brushless or stepper), internal rotor motors with hollow rotor. The annular receptacle is one contemplated solution to accommodate the stator core of the motor to drive a rotation of the rotor assembly 50.

In an embodiment, bearings or bearing assemblies are generically shown as 54. The bearing assemblies 54 are the parts of the rotor assembly 50 rotatingly supporting the stator assembly 60, such that the rotor assembly 50 may rotate about the stator assembly 60 as a result of actuation input from the motor. The bearing assemblies 54 may include one or more bearings any suitable type, gears or a gear box (that may also be part of the stator assembly 60), seals, etc.

The stator assembly 60 is shown in a simplified configuration, with a casing shell 61. The casing shell 61 forms part of the structure of the stator assembly 60, as it is via the casing shell 61 that the stator assembly 60 connects the wrist device 40 to the motorized joint unit 30. Although not shown, the shell 61 may be covered by a shell of a link 20. The casing shell 61 has an outer wall 61A, that may be tubular, such that components of the rotor assembly 60 may be located inside of the shell 61. Connection blocks 61B may be circumferentially distributed on an inner surface of the outer wall 61A, for connection of the force sensor assembly 100 to the shell 61. The connection blocks 61B may be integrally formed with the shell 61, such as by being monolithically cast as part of the shell 61. The connection blocks 61B may have threaded bores, machined therein or as inserts, for receiving fasteners. Other arrangements are considered, with the inner surface of the outer wall 61A being for instance threaded. The shell 61 is rotatably connected to the rotor assembly 50, for instance by the bearing assemblies 54 surrounding the shaft 51 such that the shell 61 may rotate about axis X.

Still referring to FIG. 3, the shell 61 may have a coupling portion 62 at an end thereof. The coupling portion 62 is the part of the shell 61 the supports the stator core 63. The coupling portion 62 may have a radial portion 62A and a shaft portion 62B. The shaft portion 62B may be concentric with the shaft 51, with the bearing assemblies 54 being between the shaft portion 62B and the shaft 51. The shaft portion 62B may therefore rotate about axis X relative to the shaft 51. The shaft portion 62B has the stator core 63 thereon.

As observed, the drum 52C of the rotor assembly 50, and the shaft portion 62B of the stator assembly 60 are axially aligned, in that the shaft portion 62B is radially inward of the drum 52C. As a result, an annular space is defined between the shaft portion 62B and the drum 52C, in which the stator core 63 or like actuator is received. The drum 52C therefore defines a rotor ring with magnets 52D opposite the stator core 63 that is secured to the shaft portion 62B, such that actuation of the stator core 63 causes a rotation of the rotor assembly 50.

The above arrangement is provided as an example only, as a reverse arrangement is contemplated as well, for instance with a motor having an inner rotor/outer stator configuration. In such an arrangement, the tubular member 52A, or like outer wall or radially inward annular surface, may be part of or integral to the inner shell 61.

A connection unit 64 is also schematically shown in FIG. 3, and is tasked with establishing a communications link between one of the PCBs 65 (printed circuit board) and other parts of the control system, located proximally. For example, wires passing through the shaft 51 may be connected to the connection unit 64. The connection unit 64 may take various forms, such as brushes, cable spool, etc. In an embodiment, the connection unit 64 is a signal transmission device as described in PCT patent application no. PCT/CA2022/050013, incorporated herein by reference. Other PCBs 65 may be located in the wrist device 40, with appropriate wires to connect the PCBs 65 to the wired components on the end face 42 and/or on the integrated interface 45 of the wrist device 40.

The motorized joint unit 30 may optionally incorporate a primary brake system used during normal operation of the robot arm 10. The primary brake system may be for instance as described in U.S. Pat. No. 10,576,644, incorporated herein by reference. The primary brake system may be actuated during a controlled operation of the robot arm 10, by which the orientation between links 20 is adjusted based on commands from a controller, etc. The primary brake system may for instance block rotation when given orientations between links 20 are achieved. In a variant, the robot arm 10 relies on inertia and/or internal frictional forces for braking.

Another brake system, shown as 66, may be referred to as a secondary brake, a back-up brake, an auxiliary brake, an emergency brake, and is tasked with generally preserving the configuration of the robot arm 10, i.e., immobilizing the robot arm 10, if the primary brake system, if present, does not operate. The primary brake system, if present, may not operate for various reasons, among which are power outages, control system failures, emergency situations, mechanical failure, as examples among others. In an embodiment, the brake system 60 may be used as a primary brake system. The brake system 66 is only optional and is shown schematically.

Still referring to FIG. 3, the base 70 has a tubular portion or shaft 71. The tubular portion 71 may be concentric with the shaft 51 of the rotor assembly 50. The tubular portion 71 may be hollow, for wires to extend from a downstream link 20 to the wrist device 40. The tubular portion 71 may have a connector plate 71A at its proximal end, as one possibility among others, to be connected to a shell of a link 20. A disk 71B may optionally be at the distal end, to serve as reference for a position encoder. The connector plate 71A is part of the skeleton by which the motorized joint unit 30 is connected to a proximal one of the links 20. The base 70 may further include a support 72 or like structural component, by which it may rotatingly support the stator assembly 60, via bearing assembly 73. Therefore, the stator assembly 60 may rotate relative to the base 70, and the rotor assembly 50 is rotatingly supported by the stator assembly 60 such that it may also rotate relative to the base 70.

The reduction mechanism 80 may be mounted to a proximal end of the shaft 51. The reduction mechanism 80 may have a part thereof connected to the support 72, depending on the type of reduction mechanism 80. In a variant, the reduction mechanism 80 is a strain wave gear system, also referred to as harmonic gearing. The reduction mechanism 80 may therefore have a wave generator 81 mounted on the shaft 51 so as to rotate with the rotor assembly 50. A circular spline 82 is part of the support 72, and is fixed to the base 70. A flex spline 83 is connected to the stator assembly 60. Therefore, by operation of the reduction mechanism 80, the stator assembly 60 is driven in rotation but at a given reduction ratio relative to a speed of rotation of the rotor assembly 50. For example, a reduction ratio of 100:1 may be achieved, depending on the gearing in the reduction mechanism 80. Other types of reduction mechanisms may be used as alternatives to a strain wave gear system, such as planetary gear systems, gear boxes, etc. The strain wave gear system is merely provided as an example.

Referring concurrently to FIGS. 3-7, the force sensor assembly 100 is shown in varying levels of details. The force sensor assembly 100 may be used to measure forces in the robot arm 10, such as forces at the end effector and/or at the wrist device 40. In an embodiment, the force sensor assembly 100 is used to produce force related data, such as forces, torque, pressures, accelerations, etc. For simplicity, the expression used herein is “force sensor”, but the force sensor assembly 100 may produce force-related data in other forms. However, one known way to refer to the force sensor assembly 100 is as a 6-axes force-torque sensor assembly, due to the capacity of the force sensor assembly 100 to measure three-axis torque and three-axis force, though the force sensor assembly 100 may be measure fewer than three-axis torque and three-axis force in a variant. Therefore, the use of the expression “force sensor assembly” herein is not intended to limit the capacity of the sensor assembly shown.

The force sensor assembly 100 may have a structure 110, a sensor assembly 120, and/or a tool support member 130, with or without other components. The structure 110 is provided to interface the force sensor assembly 100 to the structure of the robot arm 10, such as to the shell 61 in FIG. 3. The structure 110 is also configured to support the sensor assembly 120, in terms of defining a measured portion of the force sensor assembly 100 (i.e., upon which sensors are applied), and of physically supporting the sensor assembly 120. The sensor assembly 120 may include all active components of the force sensor assembly 100, enabling same to be wired to the controller system of the robot arm 10 for providing readings related to forces. The tool support member 130 may be present to physically support a tool connected to the working end 11 of the robot arm 10, as manipulated by the wrist device 40. The tool support member 130 may also support the wrist device 40. The tool support member 130 may thus form part of the structure or skeleton of the robot arm 10, and transmits forces from the end effector or like tool to the structure 110.

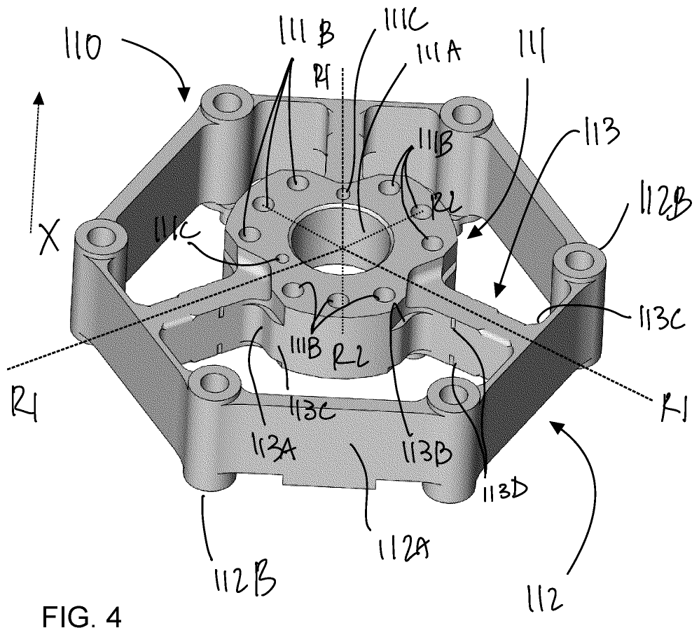

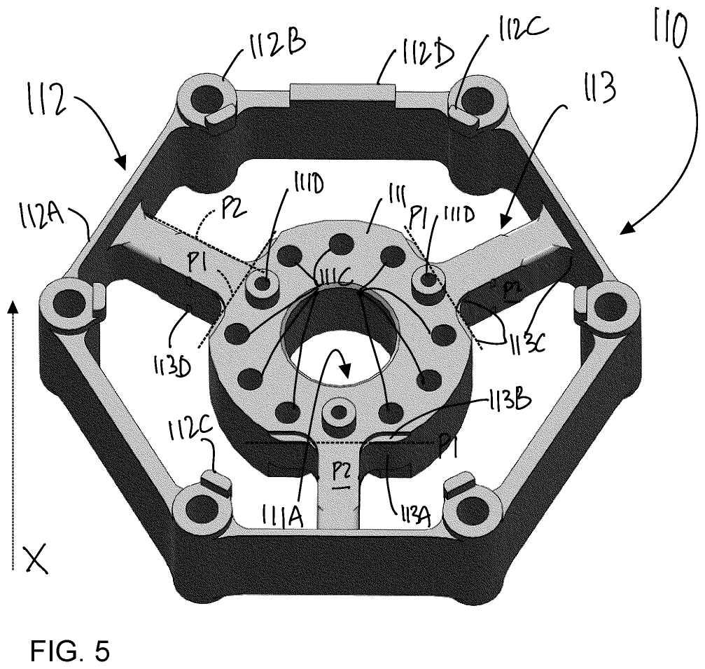

Referring to FIGS. 4 and 5, the structure 110 of the force sensor assembly 100 is shown in greater detail. The structure 110 has a connection plane, to which a vector of axis X is normal, though other arrangements are contemplated. The structure 110 has a hub 111, with other names being possible for component 111 including a core, a central structure, an inner ring, etc. The hub 111 may be central, and may define optionally a central bore 111A, giving the hub 111 an annular shape. In FIG. 4, a distal face of the hub 111 is shown, i.e., the face closest to the working end 11 of the robot arm 10. The central bore 111A, if present, may be a passage for wires. The distal face of the hub 111 may have sets of connection bores 111B, for connection of the tool support member 130 to the hub 111. Although three sets of three connection bores 111B are shown, more or fewer connection bores 111B may be present. As seen in FIG. 5, the connection bores 111B may extend through the hub 111, or may be closed ended. The connection bores 111B may optionally be threaded, for instance by tapping an interior of the surface of the connection bores 111B, It is also contemplated to have threaded inserts within the connection bores 111B as another possibility. Alignment bores 111C may optionally be present, in a non-axisymmetric manner, for proper alignment of the tool support member 130 with the hub 111. The alignment bores 111C are optional, and may be referred to as clocking features. The alignment bores 111C are configured to receive pins or like projecting features, for the tool support member 130 to have a single possible orientation on the hub 111, if desired.

Referring to FIG. 5, posts 111D may be present, for instance as projecting from a proximal face of the hub 111. The posts 111D may serve to secure a PCB of the sensor assembly 120 to the hub 111, in a spaced apart manner so as to limit heat conduction. The posts 111D may be threaded, as tapped or via inserts, as an option.

A support ring 112 or like annular structure surrounds the hub 111. The support ring 112 is shown having a polygonal shape such as an hexagonal shape, with six straight segments 112A, separated by connection blocks 112B. However, other shapes are considered, such as round or cylindrical, among others, as alternatives to the hexagonal shape. The expressions “support ring” and “annular structure” include noncircular geometries, i.e., closed figures surrounding an opening. The hexagonal shape shown may reduce the thermal contact between the support ring 112 and the shell 41 and/or shell 61, for example by having the walls of the hexagonal shape spaced from the generally inner cylindrical surface of the shell 61. The connection blocks 112B may be generally cylindrical and/or tubular, for fasteners such as bolts or screws to be used to fasten the support ring 112 to the connection blocks 61B in the shell 61 (FIG. 3), with the connection blocks 112B being coaxial with the connection blocks 61B. Not all of the blocks 112B need fasteners (some of the blocks may be abutments only), though it may be suitable for all blocks 112B to have fasteners to ensure a generally even loading between the support ring 112 and the shell 61. Tabs 112C may optionally project from the connection blocks 112B, for instance in a proximal direction, to ensure that the support ring 112 is in a predetermined relation when secured to the shell 61 (FIG. 3). More specifically, the tabs 112C may remove play between the support ring 112 and the shell 61. A layer of insulating material, or a material with lower thermal conductivity, may be present on the connection blocks 112B and/or tabs 112C to limit heat conduction.

Referring to FIGS. 4 and 5, one or more of the straight segments 112A may have a clocking feature 112D, for the structure 110 to be oriented in a desired manner. For example, the clocking feature 112D may penetrate into a corresponding clearance in the shell 61. Such an arrangement would create mechanical interference unless the structure 110 is oriented in the unique possible orientation relative to the shell 61. This is an optional arrangement, and other alignment members may be present if alignment is necessary.

Referring to FIGS. 4 and 5, branches 113 extend from the hub 111 to the support ring 112. In an embodiment, there are three branches 113, though there may be more or fewer. The branches 113 may be 120 degrees apart, so as to define some level of axisymmetry for the hub 111 and branches 113. Stated differently, three “pies” may be generally the same, such as passing through radial lines R1 or R2 (for example with the exception of alignment bores 111C), and other such radial lines may be present. The connection bores 111B may contribute to the axisymmetry of the assembly as well, as can be observed from FIG. 4. In the illustrated variant, the connection bores 111B are circumferentially offset from the branches 113 (e.g., connection bores 111B are not in the radii of the branches 113). It may be said that the branches 113 and the hub 111 (and optionally the annular structure 112) are generally axisymmetric, in that a geometry is axisymmetric, and most components contribute to the axisymmetry, and smaller components (e.g., clocking features) can be disregarded as they do not have a significant impact on weight distribution. Accordingly, torque sustained by the tool support member 130 may generally be evenly distributed to the branches 113, via the hub 111. Moreover, the empty volumes defined between the hub 111, the support ring 112 and the branches 113 may allow access to proximal components from a distal position, and facilitate assembly. Thus, at least 60% of an annular space between the hub 111 and the support ring 113 is free of structure material. In an embodiment, the structure 110 has a monoblock construction.

At a junction between the hub 111 and the branches 113, flats 113A (i.e., flat surfaces) may be formed, disrupting a cylindricality of the hub 111. The flats 113A may cause the branches 113 to be longer, and hence more sensitive to torque. Stated differently, with reference to FIG. 5, the branches 113 are perpendicular to a plane P1 in which lie their respective flats 113A. Stated differently, planes P2 passing through the flat surfaces of the branches 113 are perpendicular to the plane P1 in which lie their respective flats 113A. Stated differently, the branches 113 merge or connect into planar surfaces (e.g., flats 113A) of the hub 111. The flats 113A may be optional. The presence of flats 113A may allow the branches 113 to have a greater length than if the hub 111 was cylindrical—the hub 111 being non cylindrical. Shoulders 113B may also be present at the junction with the hub 111, to reduce localized stresses at the junction. Likewise, fillets 113C may be present between the branches 113 and the flats 113A and/or between the branches 113 and the shoulders 113B and/or between the branches 113 and the support ring 112, to strengthen the junctions.

The branches 113 may be shown as having flat surfaces, for receiving strain gauges thereon. In an embodiment, the branches 113 have a rectangular cross section, through other cross sections are contemplated (e.g., square, circular, triangular, squircle, hexagonal). The presence of flat surfaces may be well suited for receiving strain gauges thereon, as it may be easier to precisely locate the strain gages if the surfaces are both flat and parallel. For example, tooling may be developed so as to press both sides/strain gages equally and in a parallel/opposed manner at the same time. The cross-section may vary in a radial direction R1 as illustrated. As the stress through the branches 113 is larger near the hub 111, a variable cross-section (smaller towards the exterior, larger near the center) may allow a near-constant stress under the glued strain gage. Channels or other indentations/marks 113D may also be defined, the channels 113D or like marks being optionally present to aid in positioning the strain gages in the correct location, by adding a visual-tactile reference that may then be lined up with arrows printed on the strain gage element itself.

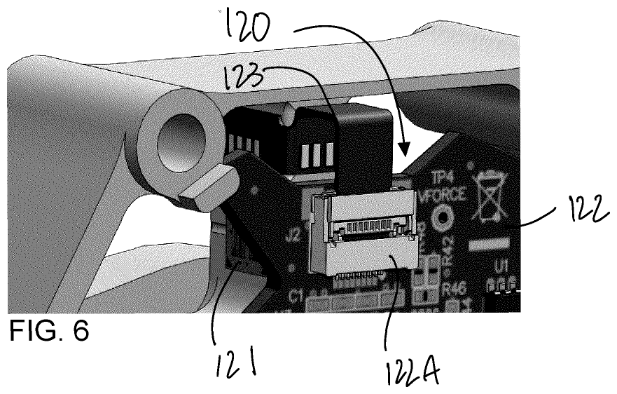

Referring to FIG. 6, the sensor assembly 120 is shown. In an embodiment, the sensor assembly 120 has a suitable arrangement to allow 6-axis force sensing (i.e., three-axis torque and three-axis force). The sensor assembly 120 has sensors or sensing elements to measure values associated with the forces, such as deformation. Any appropriate type of sensor may be used, in any particular arrangement. For example, the sensors may be polled at a minimum frequency of 1000 Hz. In an embodiment, the sensors are strain gauges 121 that are adhered or fixed to the surface(s) of the branches 113. In an embodiment, all branches 113, e.g., the three branches 113, support strain gauges 121. In an embodiment, all flat surfaces of the branches 113, e.g., four flat surfaces, have a strain gauge 121, with the strain gauges arranged in a Wheatstone bridge, as a possibility. A PCB 122, e.g., of the rigid type, may be mounted to the posts 111D, such that the PCB 122 is spaced from the proximal face of the hub 111, and is in a proximal location. In a variant, a plane of the PCB 122 may be parallel to a plane of a proximal face of the hub 111. The PCB 122 may support the electronic components required for the force sensor assembly 100 to perform force measurements. Moreover, the PCB 122 may have additional sensors, such as temperature sensors, etc.

In an embodiment flexible PCBs 123 extend from one of the strain gauges 121 to a connector 122A on the PCB 122. The flexible PCBs 123 may extend from the strain gauge 121 that is on a proximally oriented surface of the branch 113 as an option. The flexible PCBs 123 may further be wrapped around the branch 113 to connect with the other strain gauges 121, such that all strain gauges 121 of a same branch 113 are connected by flexible PCB. Alternatively, the strain gauges 121 of a set of a branch 113, e.g., the Wheatstone bridge, may be wired to one another and/or to the PCB 122. The optional configuration featuring the flexible PCBs 123, which links the strain gages 121 to the main sensing PCB 122, is a compact design compact. In terms of assembly, it may facilitate soldering and may result in lower noise levels.

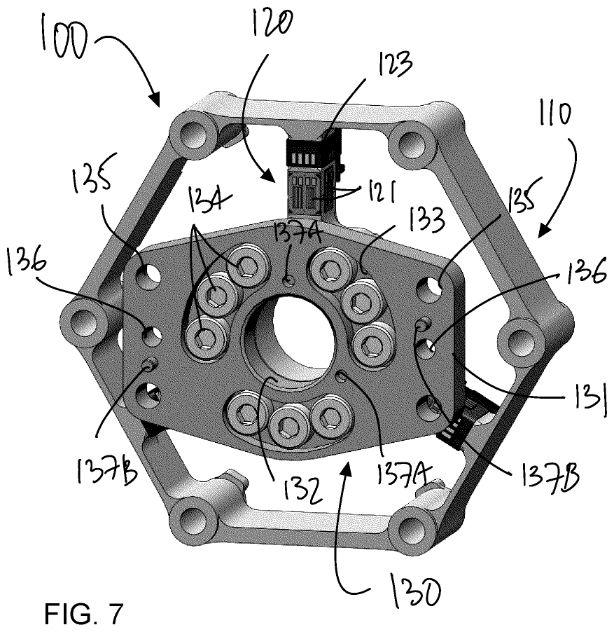

Referring to FIG. 7, the tool support member 130 is shown connected to the structure 110. More particularly, as shown in FIG. 7, the tool support member 130 may be fixed to the hub 111. The tool support member 130 may have a plate body 131, of any appropriate shape. In the illustrated embodiment, the plate body 131 has six sides and an elongated shape, with rounded corners. However, other shapes are considered, such as rectangular, square, round, squircle, elliptical, among others. A bore 132 may be provided in the plate body 131, and may be aligned with the central body 111A of the hub 111. The aligned bores 111A and 132 may define a wire passage, as a contemplated arrangement.

Groove(s) 133 may be formed in the distal surface of the plate body 131, so as to accommodate heads of fasteners 134 for them not to project beyond a distal plane of the distal surface of the plate body 131. The grooves 133 may be optional, as the instruments attached to the plate body 131 (e.g., the end plate 42) may be spaced from the plate body 131. In an embodiment, the fasteners 134 are bolts. The bolts 134 have their sockets facing in a distal direction, and project beyond a proximal surface of the plate body 131 to be threadingly engaged into connection bores 111B (FIG. 4). The reverse arrangement is also contemplated. The bolts 134 may optionally be in the same axisymmetry arrangement described above, e.g., with the three pies, to assist in evenly distributing torque to the structure 110.

Still referring to FIG. 7, bores 135 may be defined in the plate body 131, as one possible way to connect the end plate 42 or an end effector to the plate body 131. For example, spacer blocks 135A (one shown in FIG. 3) may be present between the tool support member 130 and the end plate 42, such that the wrist device 40 is connected and supported by the tool support member 130, via the spacer blocks 135A. A single spacer block 135A could be present, for example spanning both ends of the plate body 131. The spacer blocks 135A may also be integral with the tool support member 130 or with the end plate 42 or other component of the wrist device 40. If present, different sizes of spacer blocks 135A may be used as a function of the size and/or configuration of the wrist device 40. The bores 135 may be in axial alignment with the holes accommodating the fasteners 44B (FIG. 2) in the end face 42 of the wrist device 40, and with throughbores in the spacer blocks 135A if present. Therefore, the fasteners 44B of the end plate 42 may penetrate through connection holes to engage into the bores 135, for instance via the spacer blocks 135A. The bores 135 are consequently sized, and may be threaded for this purpose. Posts, threaded rods, etc are some of the alternatives among others to the bores 135 in the tool support member 130. Additional bores 136 may also be present, for example to permit pre-alignment or pre-installation (ex. of a sub-assembly) prior to the full module assembly. As such, these bores 136 may be smaller than bores 135 as they are not the principal load path during use of the sensor. The bores 135 are radially outward of the bolts 134 and holes by which the tool support member 130.

Positioning pins 137A and 137B may be present in the tool support member 130. The positioning pins, also known as alignment pins or clocking features, are used to position the tool support member 130 on the structure 110 in a predetermined manner. For example, the pins 137A, shown as holes, project from a proximal face of the tool support member 130 and are received in the alignment bores 111C in the hub 111. The positioning pins 137B may serve the same purpose, with the components that are against the distal face of the tool support member 130.

Referring to FIGS. 5 and 7, dimensions of the force sensor assembly 100 may be as described below, as an example among others is between 55 mm and 85 mm, and a height (in the axial direction) is between 12 mm and 22 mm. A cross section of the branches 113, where the sensors are located, is rectangular with one side ranging between 5 and 9 mm and the other side between 7 and 10 mm. A maximum diametrical dimension of the support ring 112 is between 55 mm and 85 mm. The tool support member has a maximum dimension ranging between 52 mm and 58 mm and a height (in the axial direction) between 6 mm and 8 mm in order to fully embed the screw heads. In an embodiment, the hub 111 has a largest diametrical dimension ranging between 33 and 40 mm, as an example.

The arrangement shown in FIGS. 3 to 7 may include an integrated thermal insulation from the largest heat sources in the robot arm 10. The wrist device 40 may be thermally independent from the closest motorized joint unit 30 using an active thermal control. A temperature calibration may for example be performed in order to compensate for the thermal expansion of the branches 113. Optionally, a thermal heater could be included to perform closed-loop temperature control of the structure 110 to maintain a constant temperature. The thermal heater may include coils or resistor elements in conductive contact with any part of the structure 110, as a possibility, such as in the central hub 111.

The wrist device 40 and force sensor assembly 100 may be said to define an integrated 6-axis force-torque sensor embedded or designed to be embedded in the robot arm 10, and in its handling device, i.e., the wrist device 40. In an embodiment, the force sensor assembly 100 uses a three-branch configuration and full-bridge wiring, with the top cross-sections sized to the sensor width. There may be reduced or minimal thermal contact at the outer circumference between the shells 41 and 61, notably because of the hexagonal shape of the support ring 112.

1. A force sensor assembly for a mechanism, comprising:
an annular structure configured for securing the force sensor assembly to a link of a mechanism;
a hub configured to be connected to a support a tool;
branches extending from the hub to the annular structure, the branches defining sensor receiving surfaces; and
sensors on the sensor receiving surfaces.

2. The force sensor assembly according to claim 1, comprising three of the branches.

3. (canceled)

4. The force sensor assembly according to claim 1, wherein the branches and the hub are generally axisymmetric.

5. (canceled)

6. The force sensor assembly according to claim 1, wherein the branches are perpendicular to respective surfaces of the hub to which the branches connect.

7. The force sensor assembly according to claim 1, wherein the branches are perpendicular to respective surfaces of the annular structure to which the branches connect.

8. The force sensor assembly according to claim 1, comprising fillets at junctions between the branches and the hub.

9. The force sensor assembly according to claim 1, comprising fillets at junctions between the branches and the annular structure.

10. The force sensor assembly according to claim 1, wherein the sensor receiving surfaces are flat.

11. The force sensor assembly according to claim 10, wherein planes of the sensor receiving surfaces are perpendicular to planes of respective surfaces of the hub to which the branches connect.

12. (canceled)

13. (canceled)

14. The force sensor assembly according to claim 1, wherein the annular structure is polygonal.

15. (canceled)

16. The force sensor assembly according to claim 1, wherein the hub defines a central opening.

17. (canceled)

18. (canceled)

19. The force sensor assembly according to claim 1, including a printed circuit board connected to the sensors.

20. The force sensor assembly according to claim 19, wherein at least one post projects from the hub, the printed circuit board connected to the at least one post.

21. (canceled)

22. The force sensor assembly according to claim 19, including flexible circuits extending from the sensors to the printed circuit board.

23. The force sensor assembly according to claim 1, further comprising a tool support member connected to the hub and configured to interface a tool to the hub.

24. The force sensor assembly according to claim 23, wherein the tool support member has a plate body with an elongated shape, the plate body in planar engagement with a surface of the hub.

25. The force sensor assembly according to claim 24, wherein hub connection holes in the tool support member for connection with the hub are inward of tool connection holes in the tool support member for connection with the tool.

26. The force sensor assembly according to claim 23, wherein clocking features are present between the tool support member and the hub for providing a unique orientation engagement therebetween.

27. The force sensor assembly according to claim 23, wherein the tool support member has a central opening in register with a central opening in the hub.

28. A robot arm comprising:
at least one link having a motorized joint unit;
a wrist device; and
the force sensor assembly according to claim 1 between the motorized joint unit and the wrist device, the wrist device being to the tool and the at least one link being the mechanism.

29.-31. (canceled)
